(19) United States
(12) Patent Application Publication
(10) Pub. No.: US 2006/0075795 A1
(43) Pub. Date: Apr. 13, 2006

(54) Key operated lock assembly with restricted keyway slot and keyblank for forming a key usable therewith

(76) Inventor: Alan E. Lurie, Centerport, NY (US)

Correspondence Address: UNITED STATES SURGICAL,;A DIVISION OF TYCO HEALTHCARE GROUP LP, 150 GLOVER AVENUE, NORWALK, CT, 06856, US

(21) Appl. No.: 11/243,856

(22) Filed: Oct. 5, 2005

Related U.S. Application Data
(60) Provisional application No. 60/615,917, filed on Oct. 5, 2004.

(51) Int. Cl. E05B 9/04; E05B 19/04; E05B 19/16

(52) U.S. Cl. 70/406; 70/375

(57) ABSTRACT

The present disclosure is directed to a lock assembly including a lock core defining a keyway slot. The keyway slot has a restricted configuration which includes a projection defining an undercut. A key blank is also described which defines a longitudinal groove configured and dimensioned to receive a projection defining an undercut.

This application claims priority from U.S. provisional patent application Ser. No. 60/615,917 filed Oct. 5, 2004, the entirety of which is incorporated herein by reference.

### BACKGROUND

1. Technical Field

The present disclosure relates generally to key operated locks and key blanks for forming keys usable with such locks. More specifically, the present disclosure relates to key operated locks which define a keyway slot configured to allow entry of a key having only specific configuration. The present disclosure also relates to key blanks for forming a key having such specific configuration.

2. Background of Related Art

Key operated locks are an integral part of most security systems. Such locks are common in households, automobiles, retail establishments, etc. Typically, a spare or backup key for a key operated lock can be easily obtained at any hardware store by bringing in the original key and having a store clerk cut a copy from a standard key blank. Although the availability of standard key blanks is convenient for most homeowners and car owners, most retailers do not want their keys to be easily reproduced for obvious reasons.

Most key operated locks include a movable, e.g., rotatable, core having a keyway slot configured to receive a key. Typically, the keyway slot includes a projection on one or both sides of the keyway slot. A cutout, or cutouts, is formed in an operating key for slidably receiving the projection or projections to allow a key to enter the keyway slot. Standard keyblanks having such cutouts for receiving the keyway slot projections are readily available. Thus, the standard keyblank can enter the keyway slot of most standard locks. As such, the standard key blank can be easily cut to operate most standard locks. It would be desirable for security locks to include a keyway slot which is not accessible to a key formed from a standard keyblank.

Accordingly, a continuing need exists in the security systems arts for a key operated lock which includes a core having a keyway slot which is configured to prevent entry of a key into the keyway slot by a key cut from a stardard keyblank.

### SUMMARY

The present disclosure is directed to a lock assembly including a lock core defining a keyway slot. In one embodiment, the keyway slot includes a projection defining an undercut. In one embodiment, the projection is dove-tail shaped. In another embodiment, the projection is T-shaped. In yet another embodiment, the projection is L-shaped. The above-described keyway slots are configured and dimensioned to receive a key including a longitudinal groove configured to receive one of the above-described projections.

The present disclosure is also directed to a keyblank for forming a key including a longitudinal groove having a configuration to receive a projection having an undercut. In one embodiment, the longitudinal groove has a dovetail configuration. In another embodiment, the longitudinal groove has as T-shaped configuration. In yet another embodiment, the longitudinal groove has a L-shaped configuration.

The present disclosure is also directed to a lock assembly defining a keyway slot having an I-shaped configuration. The present disclosure is also directed to a keyblank for forming a key having a body having an I-shaped cross-section dimensioned to be received within a key slot of a lock core having an I-shaped configuration.

### BRIEF DESCRIPTION OF THE DRAWINGS

Embodiments of the presently disclosed key operated lock core of a lock assembly with restricted keyway slot and keyblank for forming a key usable therewith are disclosed herein with reference to the drawings, wherein:

FIG. 1 is a top view of a lock core of a lock assembly including one embodiment of the presently disclosed restricted keyway slot;

FIG. 2 is a side view of a key configured to be received within the restricted keyway slot of FIG. 1;

FIG. 3 is a perspective, cross-sectional view taken along section lines 3-3 of FIG. 2;

FIG. 4 is a top view of a lock core of a lock assembly including another embodiment of the presently disclosed restricted keyway slot;

FIG. 5 is a top view of a lock core of a lock assembly including yet another embodiment of the presently disclosed restricted keyway slot;

FIG. 6 is a top view of a lock core of a lock assembly including yet another embodiment of the presently disclosed restricted keyway slot;

FIG. 7 is a side view of a key configured to be received within the restricted keyway slot shown in FIG. 6; and

FIG. 8 is a perspective cross-sectional view taken along section line 8-8 of FIG. 7.

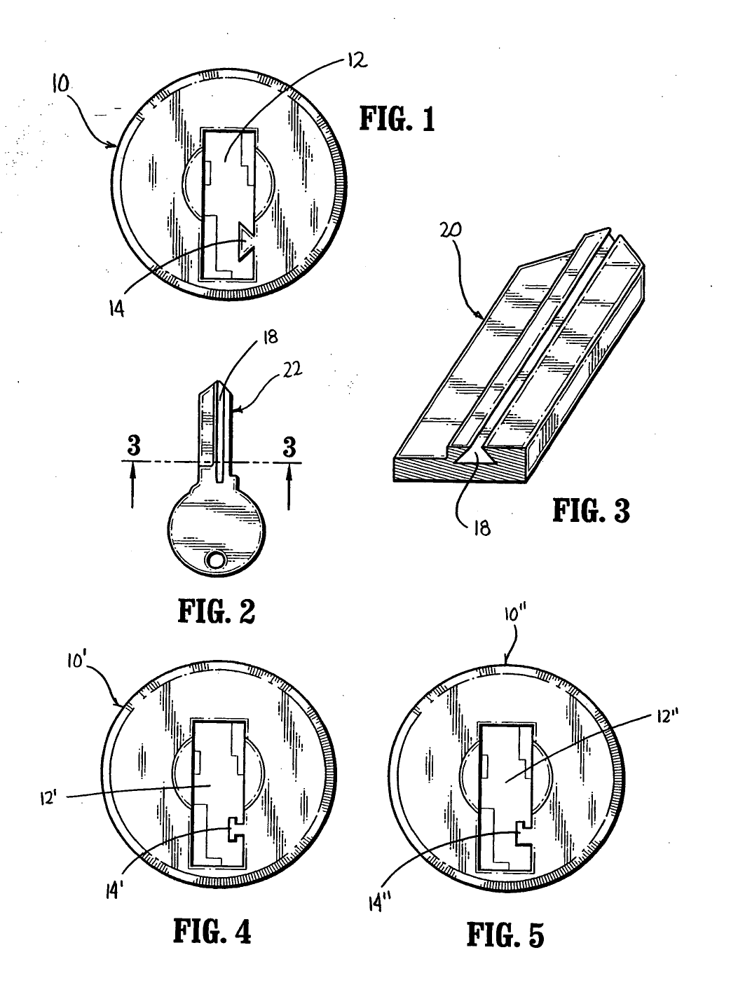

### DETAILED DESCRIPTION OF EMBODIMENTS

An embodiment of the presently disclosed key operated lock assembly with restricted keyway slot and keyblank for forming a key usable therewith will now be described in detail with reference to the drawings wherein like numerals designate identical or corresponding elements in each of the several views.

FIG. 1 illustrates one preferred embodiment of a key operated lock assembly which includes a lock core 10 having the presently disclosed restricted keyway slot 12. Keyway slot 12 includes a dovetail projection 14 which extends into keyway slot 12. Dovetail projection 14 defines an undercut and is configured to be received in sliding interlocking engagement with a longitudinal groove 18 defining an undercut formed in an operating key 22. The longitudinal groove 18 is configured to receive dovetail projection 14 to allow passage of operating key 22 into keyway slot 12. Although only one dovetail projection 14 is illustrated, two or more projections may be provided. Each keyblank 20 for forming a key usable with lock core 10 includes a longitudinal groove 18 defining an undercut which corresponds to each respective projection 14. Unlike standard keyblanks, keyblank 20 would not be readily available to consumers.

Referring to FIGS. 4 and 5, other keyway projection configurations are also envisioned. Preferably, the keyway projection is configured to be received within a longitudinal groove defining an undercut formed in an operating key such that engagement of the projection within a longitudinal groove formed in a key provides interlocking engagement between the key and the keyway slot. For example, as illustrated in FIG. 4, keyway projection 14″ may be T-shaped or as illustrated in FIG. 5, keyway projection 14″ may be L-shaped. It is noted that the projection may be symmetrical about a transverse axis extending across keyway slot 12′ as shown in FIGS. 1 and 4 or asymmetrical about a transverse axis extending across keyway slot 12″ as shown in FIG. 5. Other keyway projection embodiments are envisioned and include a half-dovetail projection or any other interlocking structure.

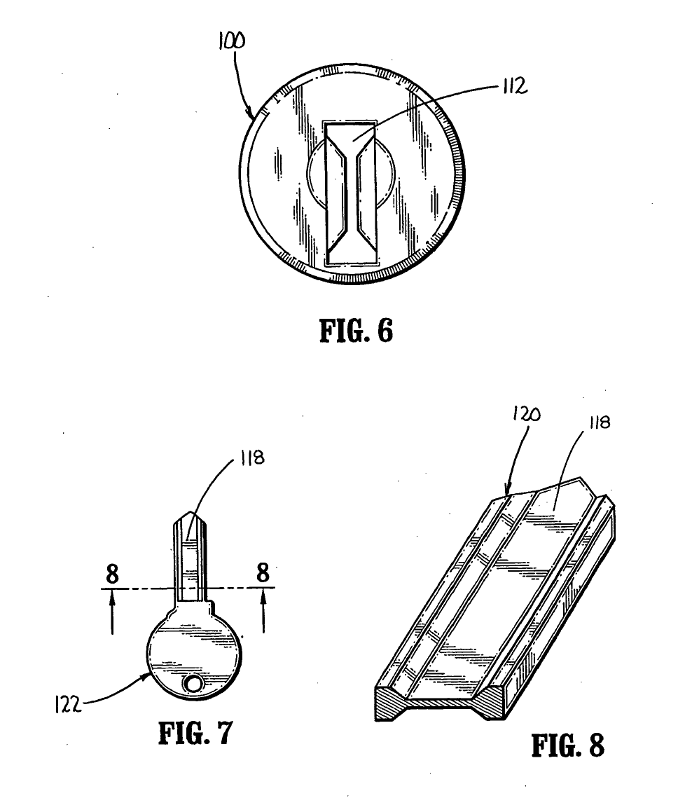

In another preferred embodiment shown in FIG. 6, core 100 includes a keyway slot 112 having an I-beam configuration. Keyblank 120 and operating key 122 have cross-sections which correspond to the configuration of keyway slot 112 to facilitate passage of a key into keyway slot 112.

It is envisioned that the keyway slot configuration can be incorporated into a variety of different key operated lock assemblies including cam locks, drawer locks, plungers locks, T-Handle locks, pad locks, removable plug locks, extension locks, switch locks, interchangeable core locks, cabinet locks, showcase locks, mail box locks, parking meter locks, handcuff locks, pay phone locks, mortise cylinder locks, rim cylinder locks, lever locks, knob locks, deadbolt locks, spring bolt locks, dead latch locks, vending locks, international cylinder locks, computer locks, bike locks, gun locks, specialty locks, cable locks, etc. Further, the lock cores, operating keys and/or keyblanks may be formed from a variety of metals or, in the alternative, be molded from plastics.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto.

What is claimed is:

1. A keyblank comprising:
a body having a longitudinal groove, wherein the longitudinal groove defines an undercut.

2. A keyblank according to claim 1, wherein the longitudinal groove has a substantially dovetail shaped configuration.

3. A keyblank according to claim 1, wherein the longitudinal groove has a substantially T-shaped configuration.

4. A keyblank according to claim 1, wherein the longitudinal groove has a substantially L-shaped configuration.

5. A keyblank comprising:
a body having a substantially I-shaped cross-section, the body being dimensioned to be received within a keyway slot of a lock core.

6. A lock assembly comprising:
a lock core defining a keyway slot, wherein the keyway slot includes a projection defining an undercut.

7. A lock assembly according to claim 6, wherein the projection has a substantially dovetail shaped configuration.

8. A lock assembly according to claim 6, wherein the projection has a substantially L-shaped configuration.

9. A lock assembly according to claim 6, wherein the projection has a substantially T-shaped configuration.

10. A lock assembly comprising:
a lock core defining a keyway slot wherein the keyway slot has a I-shaped substantially configuration.
